(19) United States
(12) Patent Application Publication
(10) Pub. No.: US 2009/0184914 A1
(43) Pub. Date: Jul. 23, 2009

(54) DRIVING DEVICE FOR GATE DRIVER IN FLAT PANEL DISPLAY

(76) Inventors: Kai-Shu Han, Hsinchu County (TW); Ching-Ho Hung, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/040,920

(22) Filed: Mar. 3, 2008

(30) Foreign Application Priority Data
Jan. 17, 2008 (TW) 097101761

(51) Int. Cl. G09G 3/36

(52) U.S. Cl. 345/100

(57) ABSTRACT

A driving device of a gate driver in a flat panel display for reducing production cost includes a plurality of addressing units, each addressing unit for generating a plurality of addressing signals, and an output control circuit for performing logic operations in order on a plurality of addressing signals generated by one of the plurality of addressing units and a plurality of addressing signals generated by another of the plurality of addressing units, for generating a plurality of channel output signals.

### BACKGROUND OF THE INVENTION

1. Field of the Invention

The present invention relates to a driving device for a gate driver in a flat panel display, and more particularly, to a driving device for reducing production cost of the gate driver.

2. Description of the Prior Art

The advantages of a liquid crystal display (LCD) include lighter weight, less electrical consumption, and less radiation contamination. LCD monitors have been widely applied to various portable information products, such as notebooks, mobile phones, PDAs, etc. In an LCD monitor, incident light produces different polarization or refraction effects when the alignment of liquid crystal molecules is altered. The transmission of the incident light is affected by the liquid crystal molecules, and thus magnitude of the light emitted from the liquid crystal molecules varies. The LCD monitor utilizes the characteristics of the liquid crystal molecules to control the corresponding light transmittance and produces gorgeous images according to different magnitudes of red, blue, and green light.

Please refer to FIG. 1. FIG. 1 is a block diagram of a TFT LCD device 10 according to the prior art. The TFT LCD device 10 includes a panel 100, a timing controller 102, a data-line-signal output circuit 104 and a scan-line-signal output circuit 106. The data-line-signal output circuit 104 includes source drivers 140 in series. The scan-line-signal output circuit 106 includes gate drivers 160 in series. FIG. 1 illustrates 3 gate drivers 160 as an example, but is not limited to this number. The data-line-signal output circuit 104 transforms a digital data signal to a voltage signal according to control signals generated by the timing controller 102, and the scan-line-signal output circuit 106 outputs the voltage signal according to a clock signal CLK and a start-up signal Diol generated by the timing controller 102, so as to control a potential difference of an equivalent capacitor of each pixel of the panel 100 for grayscale display. The data signal is input to the data-line-signal output circuit 104 in the following sequence: Pₙ(x,y), pₙ(x+1,y), pₙ(x+2,y) . . . pₙ(x,y+1), pₙ(x+1, y+1), pₙ(x+2, y+1) . . . pₙ₋₁(x, y), pₙ₊₁(x+1, y), pₙ₊₁(x+2, y) . . . pₙ₊₁(x,y+1), pₙ₊₁(x+1, y+1), pₙ₊₁(x+2, y+1) as shown in FIG. 1. In addition, an amount of source drivers 140 or gate drivers 160 in the TFT LCD device 10 depends on an amount of channels of a single source driver 140 or a single gate driver 160 and the resolution of the TFT LCD device 10.

Please refer to FIG. 2 and FIG. 3. FIG. 2 is a block diagram of the gate driver 160. FIG. 3 is a timing diagram of the gate driver 160. If the amount of channels of the single gate driver 160 is K, thereby, the gate driver 160 comprises K shifter registers 200, K level shifters 202 and K buffers 204. K level shifters 202 are respectively coupled to K shifter registers 200, and K buffers 204 are respectively coupled to K level shifters 202. The start-up signal Dio1 (or a start-up signal Dio2 in the opposite direction) and the clock signal CLK are inputted to one of K shifter registers 200. When a clock rising edge trigger occurs, the shifter register 200 passes an address to the next shifter register 200 and outputs the address to a corresponding level shifter 202. Next, the address is passed through the level shifter 202 and the buffer 204 to be a channel output signal. Therefore, K addresses, Q₁ to Q_{K}, are respectively passed to K level shifters 202, then to K buffers 204, to be K channel output signals, X₁ to X_{K}.

The gate driver 160 uses a one-hot addressing scheme to generate channel output signals. That is, a shifter register 200 and a level shifter 202 correspond to a channel output signal. With the advancement of semiconductor manufacturing and as component sizes shrink, a single gate driver is capable of comprising more channels than in the past. As a result, designing the gate driver utilizing a prior art one-hot addressing scheme cannot effectively reduce production cost of the gate driver.

### SUMMARY OF THE INVENTION

It is therefore a primary objective of the claimed invention to provide a driving device for a gate driver in a flat panel display for reducing production cost of the gate driver.

The present invention discloses a driving device of a gate driver in a flat panel display for reducing production cost comprising a plurality of addressing units, each addressing unit for generating a plurality of addressing signals, and an output control circuit for performing logic operations in order on a plurality of addressing signals generated by one of the plurality of addressing units and a plurality of addressing signals generated by another of the plurality of addressing units, for generating a plurality of channel output signals.

The present invention further discloses a driving device of a gate driver in a flat panel display for reducing production cost comprising a panel, a timing controller, a plurality of source drivers coupled to the panel and the timing controller for outputting image data to the panel, and a plurality of gate drivers coupled to the panel and the timing controller for driving the panel to display image data, each gate driver comprising a plurality of addressing units, each addressing unit for generating a plurality of addressing signals, and an output control circuit for performing logic operations in order on a plurality of addressing signals generated by one of the plurality of addressing units and a plurality of addressing signals generated by another of the plurality of addressing units, for generating a plurality of channel output signals.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a TFT LCD device according to the prior art.

FIG. 2 is a block diagram of a gate driver according to the prior art.

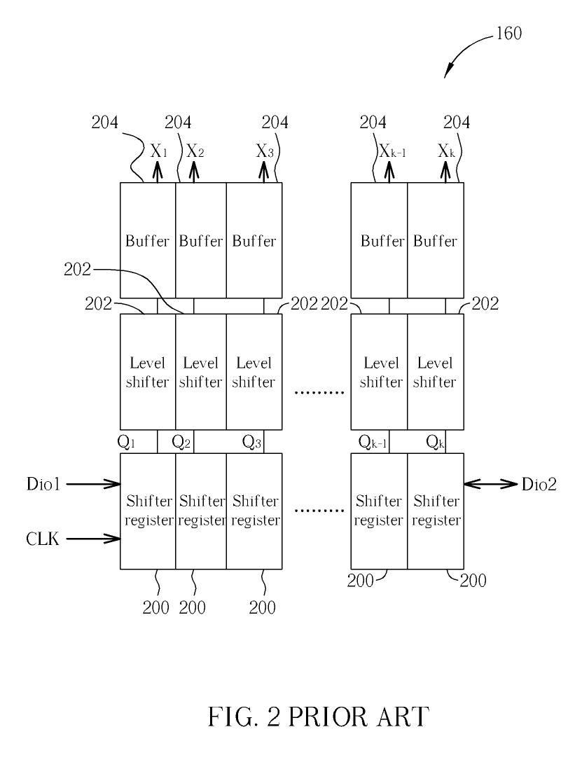

FIG. 3 is a timing diagram of the gate driver shown in FIG. 2.

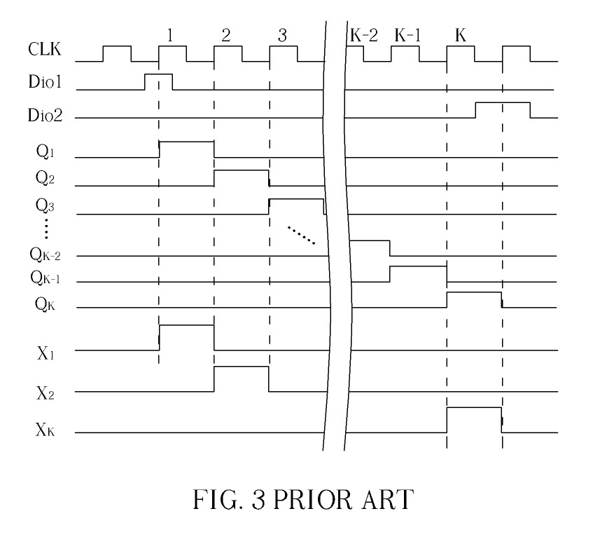

FIG. 4 is a block diagram of a gate driver according to an embodiment of the present invention.

FIG. 5 is a block diagram of a first addressing unit of the gate driver shown in FIG. 4.

FIG. 6 is a block diagram of a second addressing unit of the gate driver shown in FIG. 4.

FIG. 7 is a block diagram of an output control unit of the gate driver shown in FIG. 4.

FIG. 8 is a timing diagram of the gate driver shown in FIG. 4.

FIG. 9 is a block diagram of a gate driver according to an embodiment of the present invention.

FIG. 10 is a block diagram of a first addressing unit of the gate driver shown in FIG. 9.

FIG. 11 is a timing diagram of the gate driver shown in FIG. 9 for a double-pulse application.

FIG. 12 is a timing diagram of the gate driver shown in FIG. 9 for a long-pulse application.

FIG. 13 is a block diagram of a flat panel display device according to an embodiment of the present invention.

### DETAILED DESCRIPTION

In a gate driver using the one-hot addressing scheme, a shifter register and a level shifter correspond to a channel, so that production cost of the gate driver cannot be effectively reduced. The present invention—a gate driver using a two-stage addressing scheme—can considerably save the component area cost, thereby saving production cost of the gate driver.

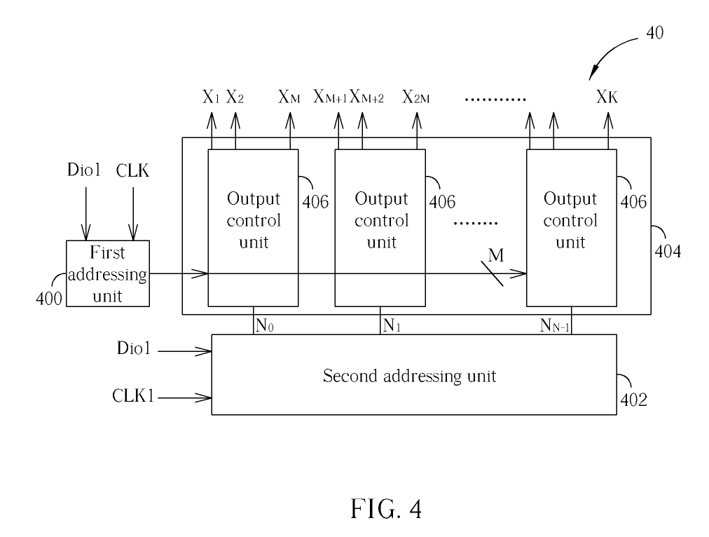

Please refer to FIG. 4. FIG. 4 is a block diagram of a gate driver 40 according to an embodiment of the present invention. FIG. 4 illustrates the gate driver 40 comprising K channels. The gate driver 40 comprises a first addressing unit 400, a second addressing unit 402 and an output control circuit 404. The first addressing unit 400 and the second addressing unit 402, for respectively implementing the first step addressing and the second step addressing, are coupled to the output control circuit 404, for generating K addressing signals corresponding to K channels. The first addressing unit 400 generates M addressing signals, M₁, M₂. . . , Mₘ . . . , M_{M}, 1≦m≦M. The second addressing unit 402 generates N addressing signals, N₀, N₁ . . . , Nₙ . . . , N_{N-1}, 0≦n≦N−1. In addition, the output control circuit 404 comprises N output control units 406 for performing logic operations on M addressing signals M₁, M₂ . . . , Mₘ . . . , M_{M} and N addressing signals N₀, N₁ . . . , Nₙ . . . , N_{N-1} to generate K channel output signals, X₁, X₂ . . . , X_{M}, X_{M+1} . . . , X_{K}.

All channels of the gate driver 40 are divided into N groups of channels, where each group comprises M channels, K≦M×N. The first addressing unit 400 generates M addressing signals M₁ to M_{M} in the first addressing step; the second addressing unit 402 generates N addressing signals N₀ to N_{N-1} in the second addressing step. Clock signals CLK, CLK1 and a start-up signal Dio1 shown in FIG. 4 are generated by a timing controller of the gate driver 40. The start-up signal Dio1 is used by the first addressing unit 400 and the second addressing unit 402; the clock signal CLK is used by the first addressing unit 400; the clock signal CLK1 is used by the second addressing unit 402 and is also a frequency dividing signal generated by the counting of the first addressing unit 400. When a clock rising edge trigger occurs, the output control unit 406 performs logic operations respectively on M addressing signals M₁, M₂ . . . , Mₘ . . . , M_{M} and the addressing signal N₀ to generate the channel output signals X₁, X₂ . . . , X_{M}. When the next clock rising edge trigger occurs, the first addressing unit 400 outputs backwards from M₁ and the second addressing unit 402 increments from N₀ to N₁. Similarly, the next output control unit 406 can also perform logic operations respectively on M addressing signals M₁, M₂ . . . , Mₘ . . . , M_{M} and the addressing signal N₁ to generate the channel output signals X_{M+1}, X_{M+2} . . . , X_{2M}. Therefore, the gate driver 40 can generate K channel output signals X₁, X₂ . . . , X_{M}, X_{M+1} . . . , X_{K} by the first addressing unit 400 and the second addressing unit 402.

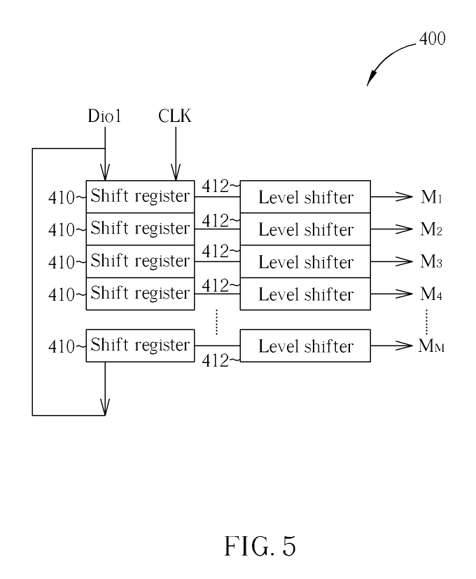

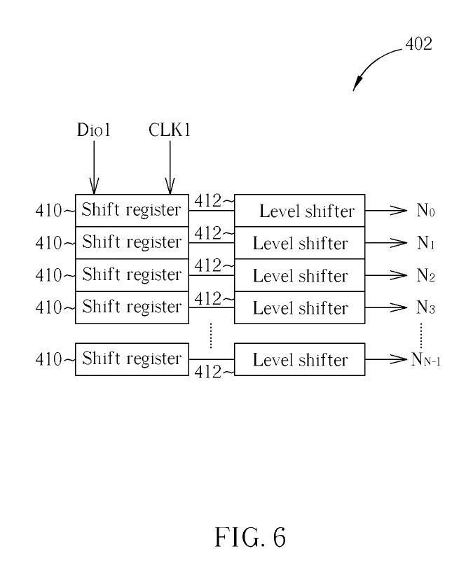

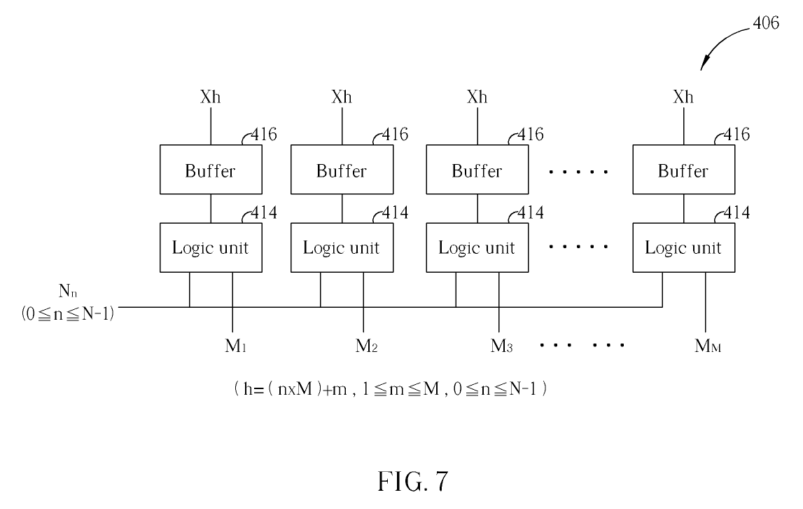

For the detailed block diagrams of the first addressing unit 400, the second addressing unit 402 and the output control unit 406, please refer to FIG. 5, FIG. 6 and FIG. 7. As shown in FIG. 5, the first addressing unit 400 comprises M shift registers 410 and M level shifters 412. When a clock rising edge trigger occurs, a shift register 410 passes an address to a next shift register 410 and outputs the address to a level shifter 412. M level shifters 412 are utilized for transforming the voltage level of addresses outputted from M shift registers 410, for generating M addressing signals M₁ to M_{M}. Similar to the first addressing unit 400, as shown in FIG. 6, the second addressing unit 402 comprises N shift registers 410 and N level shifters 412 for generating N addressing signals N₀ to N_{N-1}.

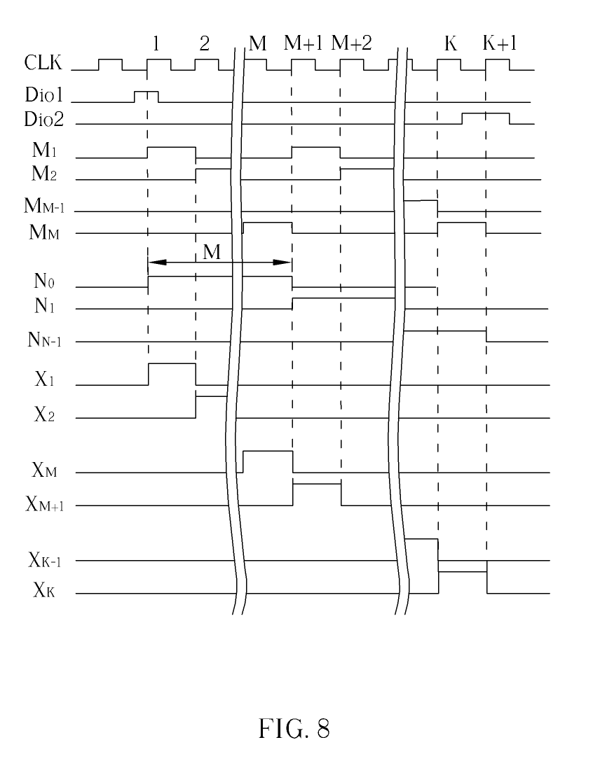

As shown in FIG. 7, each output control unit 406 of the output control circuit 404 comprises M logic units 414 and M buffers 416. M logic units 414 are utilized for performing logic operations respectively on M addressing signals M₁, M₂ . . . , Mₘ . . . , M_{M} and the addressing signal Nₙ for generating channel output signals Xₕ after M buffers 416, h=(n×M)+m, 1≦m≦M, 0≦n≦N−1. In addition, please refer to FIG. 8, which illustrates a timing diagram of the gate driver 40. The direction of a start-up signal Dio2 is opposite to the start-up signal Dio1. From the above, it can be seen that the gate driver 40 divides K channels into N groups of channels for each group comprising M channels, K≦M×N. For example, if the gate driver 40 comprises 400 channels, the first addressing unit 400 comprises 20 shift registers 410 and 20 level shifters 412 for generating addressing signals M₁, M₂ . . . , M₂₀; the second addressing unit 402 comprises 20 shift registers 410 and 20 level shifters 412 for generating addressing signals N₀, N₁ . . . , N₁₉. The output control unit 406 performs logic operations respectively on addressing signals M₁, M₂ . . . , M₂₀ and addressing signals N₀, N₁ . . . , N₁₉ for generating channel output signals X₁, X₂ . . . , X₄₀₀. That is, the gate driver 40 only needs 40 shift registers 410 and 40 level shifters 412 for generating 400 channel output signals. In the prior art, a gate driver with 400 channels using a one-hot addressing scheme needs 400 shift registers and 400 level shifters. Compared to the prior art, the present invention will greatly save the area cost of the gate driver 40.

Moreover, the gate driver 40 is only one embodiment of the present invention, and those skilled in the art can make alterations and modifications accordingly. For example, those skilled in the art can deduce a multiple-stage addressing scheme from the two-stage addressing scheme of the present invention, where the number of stages ≧2. Accordingly, the gate driver 40 can comprise a plurality of addressing units, wherein the clock signal of one of the addressing units is a frequency dividing signal generated by the counting of the former addressing signals. For example, if the gate driver 40 uses a 3-stage addressing scheme, the gate driver 40 comprises a first addressing unit, a second addressing unit and a third addressing unit. The logic operation on an addressing signal from the first addressing unit and an addressing signal from the second addressing unit generates a second-stage addressing signal. Further, the logic operation on the second-stage addressing signal and an addressing signal from the third addressing unit generates a third-stage addressing signal, called a channel output signal. From the above, it can be seen that the clock signal of the third addressing unit is a frequency dividing signal through the counting of the second-stage addressing signal. Please note that, for the gate driver 40 using a two-stage addressing scheme, the logic unit 414 is utilized for performing logic operations on two different addressing signals, while for the gate driver 40 using a multiple-stage addressing scheme, the logic unit 414 is utilized for performing logic operations on a plurality of addressing signals not limited to two addressing signals. For example, if channel output signals of the gate driver 40 are generated by an 8-stage addressing scheme, the logic unit 414 can perform logic operations on 8 addressing signals simultaneously.

In addition, the present invention can be implemented in a gate driver for double-pulse or long-pulse. Double-pulse means that two start-up signals rise during a fixed clock time interval. Long-pulse means that the pulse width of a start-up signal is larger than a clock cycle and two or more channels of the gate driver output signals in the same time. If the gate driver 40 is implemented for double-pulse or long-pulse, when addressing signals M₁, M₂ . . . , Mₘ . . . , M_{M} generated by the first addressing unit 400 are counted down and backwards from M₁, the second addressing unit 402 will generate the addressing signals Nₙ and Nₙ₊₁ at the same time, thus an error occurs.

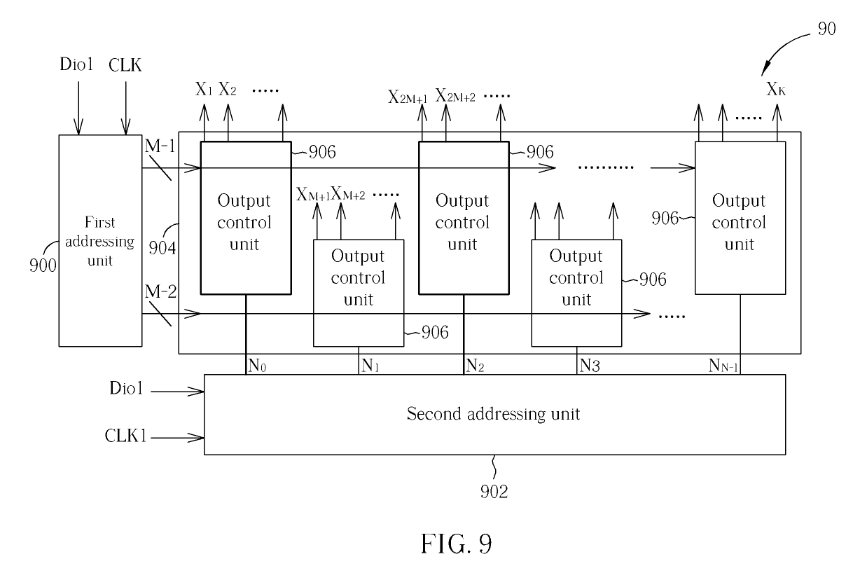

Therefore, the present invention further provides a gate driver 90, as shown in FIG. 9. The gate driver 90 uses a two-stage addressing scheme, but can also use a multiple-stage addressing scheme, where the number of stages≧2. Similar to the gate driver 40, the gate driver 90 comprises a first addressing unit 900, a second addressing unit 902 and an output control circuit 904. The output control circuit 904 further comprises a plurality of output control units 906. The second addressing unit 902 is similar to the second addressing unit 402 and a corresponding description is therefore not given here. Please note that the first addressing unit 900 is different from the first addressing unit 400.

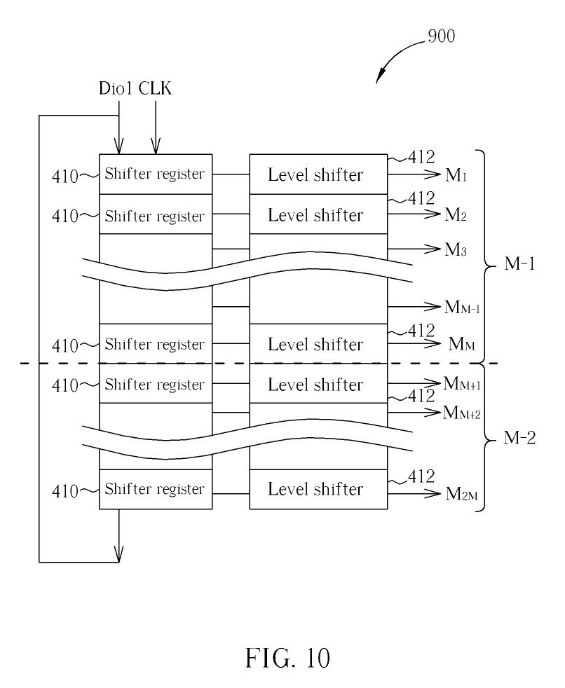

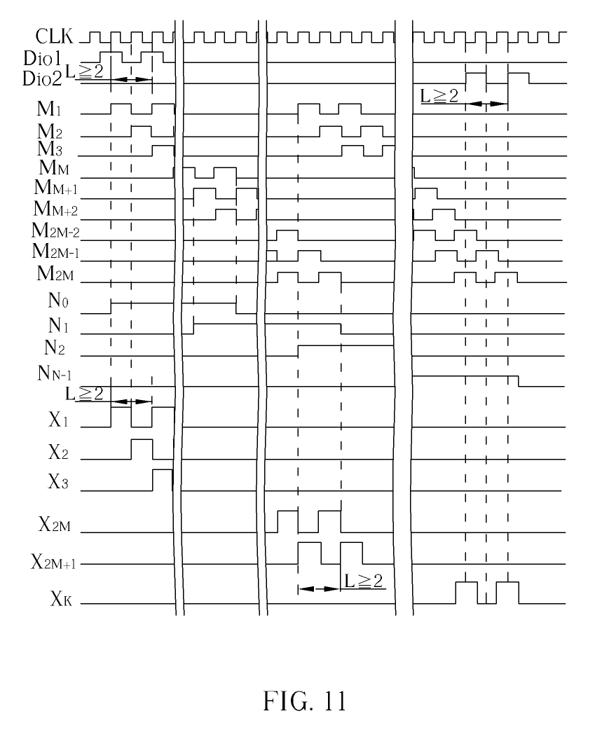

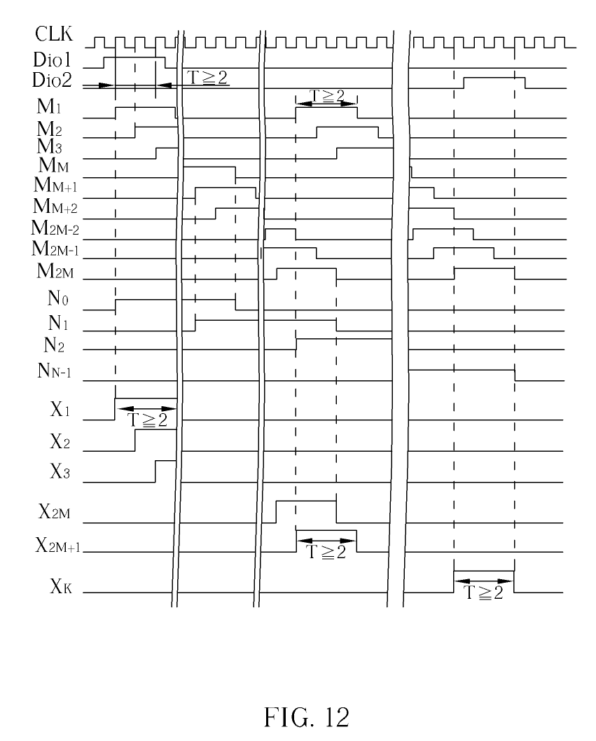

Please refer to FIG. 10. FIG. 10 is a block diagram of the first addressing unit 900. The first addressing unit 400 of the gate driver 40 comprises M shift registers 410 and M level shifters 412, while the first addressing unit 900 of the gate driver 90 comprises 2M shift registers 410 and 2M level shifters 412. As shown in FIG. 10, addressing signals generated by the first addressing unit 900 are divided into two groups, represented by (M−1) and (M−2). The former M shift registers 410 and M level shifters 412 generate addressing signals M₁ to M_{M}; the later M shift registers 410 and M level shifters 412 generate addressing signals M_{M+1} to M_{2M}. As a result, the gate driver 90 can avoid the error occurring in double-pulse or long-pulse. Clock signals CLK, CLK1 and a start-up signal Dio1 shown in FIG. 9 and FIG. 10 are generated by a timing controller of the gate driver 90. The start-up signal Diol is used by the first addressing unit 900 and the second addressing unit 902; the clock signal CLK is used by the first addressing unit 900; the clock signal CLK1 is used by the second addressing unit 902 and is also a frequency dividing signal generated by the counting of the first addressing unit 900. Please further refer to FIG. 11 and FIG. 12, which respectively illustrate timing diagrams of the gate driver 90 for double-pulse and long-pulse. As shown in FIG. 11, L represents a fixed clock time interval (L≧2), and double-pulse means that two start-up signals rise during L. As shown in FIG. 12, T_{cycle} represents the width of a clock cycle and T is the width of the start-up signal Dio1, T≧2 T_{cycle}.

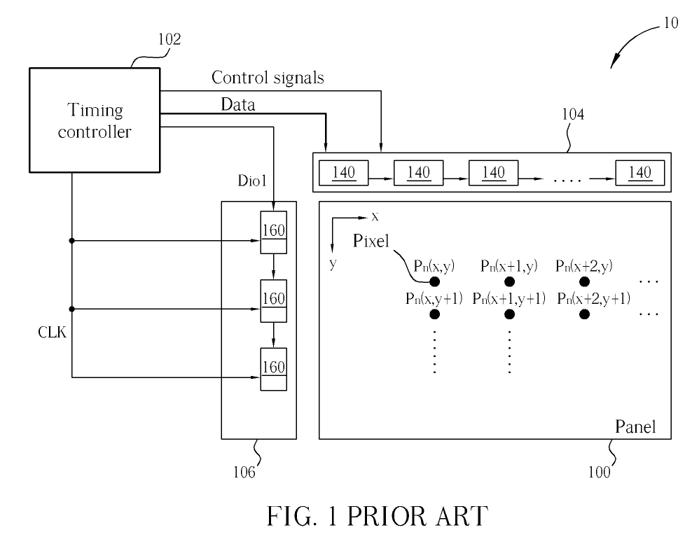

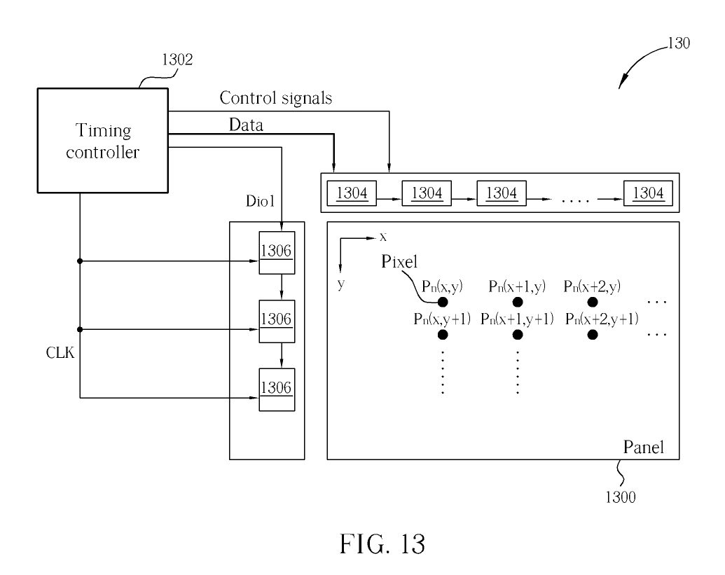

Please refer to FIG. 13. FIG. 13 is a block diagram of a flat panel display device 130 according to an embodiment of the present invention. The operation of the flat panel display device 130 is similar to the TFT LCD device 10 shown in FIG. 1 and a corresponding description is therefore not given here. The flat panel display device 130 comprises a panel 1300, a timing controller 1302, a plurality of source drivers 1304 and a plurality of gate drivers 1306. The plurality of source drivers 1304 are coupled between the timing controller 1302 and the panel 1300 for outputting image data to the panel 1300. The plurality of gate drivers 1306 are coupled between the timing controller 1302 and the panel 1300 for driving the panel 1300 to display image data. FIG. 13 illustrates 3 gate drivers 1306 as an example. The operation of the gate drivers 1306 using a two-stage addressing scheme are similar to the gate drivers 40 and a corresponding description is therefore not given here. Note that the gate drivers 1306 can also use a multiple-stage addressing scheme. Furthermore, the operation of the flat panel display device 130 can be similar to the gate drivers 90, and thus the flat panel display device 130 can be utilized for double-pulse or long-pulse. Please note that the flat panel display device 130 is not limited to be an LCD device, and can also be a PDP (Plasma display panel), OLED, Gate driver-on-array (GOA) or any other kinds of devices.

In conclusion, the present invention divides the plurality of shift registers and the plurality of level shifters into the plurality of addressing units for a multiple-stage addressing scheme. The amount of channels of the gate driver is the product of the counting of each addressing step. As a result, the present invention can considerably save the component area cost, and thereby save production cost of the gate driver.

Those skilled in the art will readily observe that numerous modifications and alterations of the device and method may be made while retaining the teachings of the invention.

What is claimed is:

1. A driving device of a gate driver in a flat panel display for reducing production cost comprising:
a plurality of addressing units, each addressing unit for generating a plurality of addressing signals; and
an output control circuit for performing logic operations in order on a plurality of addressing signals generated by one of the plurality of addressing units and a plurality of addressing signals generated by another of the plurality of addressing units, for generating a plurality of channel output signals.

2. The driving device of claim 1, wherein each addressing unit comprises:
a plurality of shift registers, each shift register for transmitting an address to a next shift register; and
a plurality of level shifters for shifting voltage level of a plurality of addresses generated by the plurality of shift registers, for generating the plurality of addressing signals.

3. The driving device of claim 2, wherein the address is generated by a timing controller of the flat panel display.

4. The driving device of claim 1, wherein the output control circuit comprises a plurality of logic units, each logic unit for performing logic operations on a first addressing signal and a second addressing signal, for generating one of the plurality of channel output signals.

5. The driving device of claim 4, wherein the first addressing signal is generated by one of the plurality of addressing units.

6. The driving device of claim 4, wherein the first addressing signal is generated by logic operations on a plurality of different addressing signals.

7. The driving device of claim 4, wherein the second addressing signal is generated by one of the plurality of addressing units.

8. The driving device of claim 4, wherein the second addressing signal is generated by logic operations on a plurality of different addressing signals.

9. The driving device of claim 1, wherein the plurality of channel output signals are utilized for driving a panel of the flat panel display to display image data.

10. The driving device of claim 1 further comprising a buffer circuit comprising a plurality of buffers for outputting the plurality of channel output signals.

11. A driving device of a gate driver in a flat panel display for reducing production cost comprising:
a panel;
a timing controller;
a plurality of source drivers coupled to the panel and the timing controller for outputting image data to the panel; and
a plurality of gate drivers coupled to the panel and the timing controller for driving the panel to display image data, each gate driver comprising:
a plurality of addressing units, each addressing unit for generating a plurality of addressing signals; and
an output control circuit for performing logic operations in order on a plurality of addressing signals generated by one of the plurality of addressing units and a plurality of addressing signals generated by another of the plurality of addressing units, for generating a plurality of channel output signals.

12. The driving device of claim 11, wherein each addressing unit comprises:
a plurality of shift registers, each shift register for transmitting an address to a next shift register; and
a plurality of level shifters for shifting voltage level of a plurality of addresses generated by the plurality of shift registers, for generating the plurality of addressing signals.

13. The driving device of claim 12, wherein the address is generated by the timing controller.

14. The driving device of claim 11, wherein the output control circuit comprises a plurality of logic units, each logic unit for performing logic operations on a first addressing signal and a second addressing signal, for generating one of the plurality of channel output signals.

15. The driving device of claim 14, wherein the first addressing signal is generated by one of the plurality of addressing units.

16. The driving device of claim 14, wherein the first addressing signal is generated by logic operation on a plurality of different addressing signals.

17. The driving device of claim 14, wherein the second addressing signal is generated by one of the plurality of addressing units.

18. The driving device of claim 14, wherein the second addressing signal is generated by logic operations on a plurality of different addressing signals.

19. The driving device of claim 11, wherein the plurality of channel output signals are utilized for driving a panel of the flat panel display to display image data.

20. The driving device of claim 11 further comprising a buffer circuit comprising a plurality of buffers for outputting the plurality of channel output signals.
